(19) United States
(12) Patent Application Publication
(10) Pub. No.: US 2007/0009171 A1
(43) Pub. Date: Jan. 11, 2007

(54) Image processor, image processing method, program and recording medium

(76) Inventors: Makoto Nakashizuka, Tokyo (JP); Hidetoshi Okazaki, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/563,284

(22) PCT Filed: Mar. 24, 2004
(86) PCT No.: PCT/JP04/04085

§ 371 Date: Jun. 2, 2006

(30) Foreign Application Priority Data
Jul. 4, 2003 (JP) 2003-270889

(51) Int. Cl. G06K 9/40

(52) U.S. Cl. 382/263; 382/266

(57) ABSTRACT

An image processor realizing noise removal and contour line emphasis simultaneously. A high-pass filter (1) outputs the high-pass components h(m,n) of input image data f(m,n). An emphasis control amount deriving section (2) determines an emphasis control amount e(m,n) by subjecting the input image data to discrete wavelet conversion. A multiplying section (3) determines and outputs the product of the emphasis control amount e(m,n) from the emphasis control amount deriving section (2) and the high-pass components h(m,n) from the high-pass filter (1) for each pixel. An amplifying section (5) multiplies the output from the multiplying section (3) by a fixed factor (λ times). An adding section (4) adds the product from the multiplying section (3) and the image data to produce output image data.

### TECHNICAL FIELD

The present invention relates to image processing apparatuses, image processing methods, and programs and recording media, and particularly to an image processing apparatus, an image processing method, and a program and a recording medium for emphasizing the brightness contrast of contour portions of an image while noise in the image is removed.

### BACKGROUND ART

In general, unsharp masking has been widely used as a method for emphasizing images. In this method, high-frequency components of input image data are obtained using a filter, are multiplied by any constant for determining an emphasis control amount, and are then added to the input image data to output an emphasized image. In the unsharp masking method, however, amplification of noise components is unavoidable if noise is superimposed on the input image data. Furthermore, when a noise-superimposed image is emphasized, noise components of the original image are amplified and appear on the result of emphasis.

In order to solve this issue, there is proposed a method for locally controlling emphasis control amounts for high-frequency components. Non-Patent Document 1 proposes a method for controlling an emphasis control amount for each pixel of input image data by multiplying a high-frequency component by a brightness gradient derived from the square sum of the central difference of brightness value in the horizontal direction and the central difference of brightness value in the vertical direction. In Non-Patent Document 2, control based on a fuzzy rule is introduced to improve the method described in Non-Patent Document 1. Patent Document 1 also proposes a noise eliminator which reverses the signs of high-frequency components with small amplitudes and adds the result to the input image data to remove noise.

Non-Patent Document 1

G. Ramponi, “A cubic unsharp masking technique for contrast enhancement,” Signal Processing, vol. 67, pp. 211-222, June, 1998.

Non-Patent Document 2

Tomoaki Kimura, Akira Taguchi, Yutaka Murata, “A Technique for Emphasizing Noise-Superimposed Images by Using Fuzzy Inference,” Transactions A, the Institute of Electronics, Information and Communication Engineers of Japan, vol. J81-A, no. 9, pp. 1247-1256, September, 1998.

Patent Document 1

Japanese Unexamined Patent Application Publication No. 2001-274995.

### DISCLOSURE OF INVENTION

Since the method described in Non-Patent Document 1 increases the amplitudes of high-frequency components only in contour portions of an image by drawing on the fact that changes in brightness are large in the contour portions of the image, this method is less effective if the brightness change in a contour portion of the image is small or a noise amplitude is large in the image. In addition, it is impossible to remove noise superimposed on input image data. Since the method described in Non-Patent Document 2 is based on a brightness gradient as the method in Non-Patent Document 1, it has the same disadvantage as the method in Non-Patent Document 1. Furthermore, the method described in Patent Document 1 is problematic in that contours with small changes in brightness are mistaken for noise and are subjected to smoothing.

In light of the above-described issues, an object of the present invention is to provide an image processing apparatus, an image processing method, and a program and a recording medium capable of realizing both noise removal and contour emphasis simultaneously.

According to the first embodiment of the present invention, there is provided an image processing apparatus for removing noise of an input image and for emphasizing contrast of a contour portion, comprising:
a filter for passing a high-frequency component of input image data therethrough;
a deriving section for obtaining first and second conversion coefficients having different magnitude relationships between an image contour portion and noise by subjecting the input image data to discrete wavelet conversion and for obtaining an emphasis control amount based on the square of the first conversion coefficient, the product of the first and second conversion coefficients, and a predetermined setting value;

a multiplying section for outputting the product of the emphasis control amount sent from the deriving section and an output of the filter; and

an adding section for obtaining output image data by adding the product output from the multiplying section and the input image data.

In addition, the deriving section can comprise:

a discrete wavelet conversion section for obtaining the first and second conversion coefficients by subjecting the input image data to discrete wavelet conversion;

a first circuit having a square circuit for squaring the first conversion coefficient;

a second circuit having a multiplier for multiplying the first and second conversion coefficients; and

a setting section for calculating and outputting a linear sum of a value obtained by multiplying an output of the first circuit by predetermined α, a value obtained by multiplying an output of the second circuit by predetermined β, and the value of predetermined γ.

According to the second embodiment of the present invention, there is provided an image processing method of removing noise of an input image and of emphasizing contrast of a contour portion, comprising:

obtaining first and second conversion coefficients having different magnitude relationships between an image contour portion and noise by subjecting input image data to discrete wavelet conversion and obtaining an emphasis control amount based on the square of the first conversion coefficient, the product of the first and second conversion coefficients, and a predetermined setting value;

outputting the multiplication value of the emphasis control amount and a high-frequency component of the input image data; and

causing an adding section to obtain output image data by adding the multiplication value and the input image data.

According to the third embodiment of the present invention, there is provided an image processing program for removing noise and emphasizing contrast in a contour portion of an input image, and a computer-readable recording medium having recorded the image processing program, the image processing program causing a computer to make a processing section execute the steps of:
reading input image data from a storage section or an input section;
obtaining first and second conversion coefficients having different magnitude relationships between an image contour portion and noise by subjecting the input image data to discrete wavelet conversion and obtaining an emphasis control amount based on the square of the first conversion coefficient, the product of the first and second conversion coefficients, and a predetermined setting value;
outputting a multiplication value of the emphasis control amount and a high-frequency component of the input image data;
causing an adding section to obtain output image data by adding the multiplication value and the input image data; and
storing the obtained output image data in a storage section and/or outputting the obtained output image data to an output section or to a display section.

### BRIEF DESCRIPTION OF THE DRAWINGS

FIG. 1 is a block diagram of an image processing apparatus.

FIG. 2 is a diagram illustrating filter coefficients of a high-pass filter.

FIG. 3 is a block diagram of an emphasis-control-amount deriving section 2.

FIG. 4 is a diagram illustrating wavelet conversion where the maximum scale is 2.

FIG. 5 illustrates example coefficients of three filters for wavelet conversion of a one-dimensional signal.

FIG. 6 is a block diagram of a filter bank for achieving two-dimensional wavelet conversion.

FIG. 7 is a diagram depicting the structures of high-pass filters and a low-pass filter for discrete binary wavelet conversion.

FIG. 8 is a diagram illustrating wavelet conversion of a one-dimensional signal and the product of scales of wavelet conversion.

FIG. 9 is a diagram depicting an example of input image data.

FIG. 10 is a diagram depicting a processing result by an unsharp masking method, which is a known method.

FIG. 11 is a diagram depicting a processing result of an emphasized image by a method described in Non-Patent Document 1.

FIG. 12 is a diagram depicting a processing result of noise removal and emphasis of contour portions being carried out simultaneously according to the present invention.

FIG. 13 is a block diagram of hardware according to the present embodiment.

FIG. 14 is a flowchart of image processing.

### BEST MODE FOR CARRYING OUT THE INVENTION

1. Image Processing Apparatus

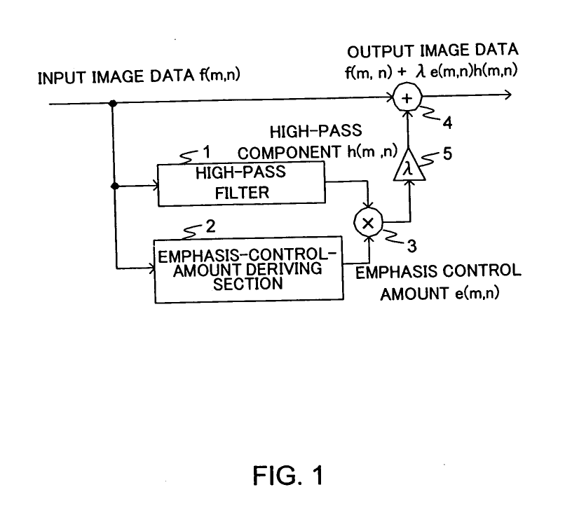

FIG. 1 is a block diagram of an image processing apparatus.

The image processing apparatus according to this embodiment includes a high-pass filter 1; an emphasis-control-amount deriving section 2; a multiplying section 3; an adding section 4; and an amplifying section 5, and removes noise of an input image and also emphasizes the contrast of contour portions.

The high-pass filter 1 allows a high-frequency component of input image data f(m,n) to pass therethrough to output a high-pass component h(m,n). For the input image data f(m,n), pixels surrounding the target pixel at coordinates (m,n) required for processing by the high-pass filter 1, the emphasis-control-amount deriving section 2, and so forth are also input as the input image data as necessary. The emphasis-control-amount deriving section 2 outputs an emphasis control amount e(m,n) for each pixel from the input image data. The emphasis-control-amount deriving section 2 obtains first and second conversion coefficients having different magnitude relationships between an image contour portion and noise by subjecting the input image data to discrete wavelet conversion, and obtains the emphasis control amount e(m,n) based on the square of the first conversion coefficient, the product of the first and second conversion coefficients, and a predetermined setting value. The multiplying section 3 obtains on a pixel-by-pixel basis the product of the emphasis control amount e(m,n) sent from the emphasis-control-amount deriving section 2 and the high-pass component h(m,n) output from the high-pass filter 1, and outputs the result. Furthermore, the amplifying section 5 can be provided as required to multiply the output of the multiplying section 3 by a constant (λ times) and output λe(m,n)h(m,n) to the adding section 4. This constant λ is a positive constant that determines the degree of emphasis and can be predetermined before processing. The adding section 4 adds the product sent from the multiplying section 3 and the input image data to obtain output image data f(m,n)+λe(m,n)h(m,n), and outputs the result.

(High-Pass Filter 1)

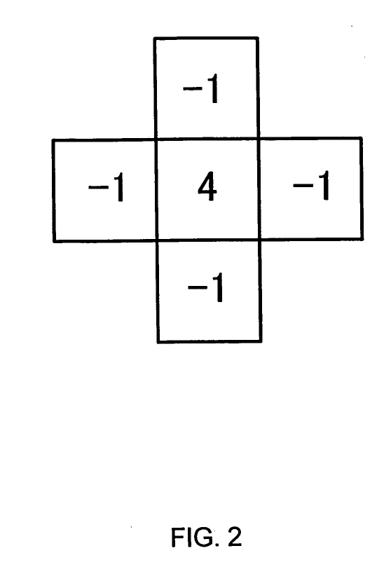

FIG. 2 is a diagram illustrating filter coefficients of the high-pass filter 1. One example of the high-pass filter 1 is a Laplacian filter with the filter coefficients shown in the figure.

(Emphasis-Control-Amount Deriving Section 2)

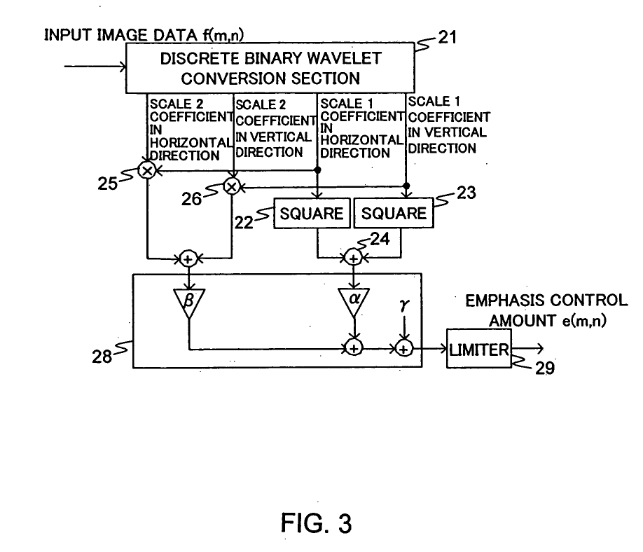

FIG. 3 is a block diagram of the emphasis-control-amount deriving section 2. In the example of this emphasis-control-amount deriving section 2, the emphasis control amount e(m,n) is derived by discrete binary wavelet conversion with two scales.

The emphasis-control-amount deriving section 2 includes a discrete wavelet conversion section 21, first and second square circuits 22 and 23, a first adder 24, first and second multipliers 25 and 26, a second adder 27, a setting section 28, and a limiter 29.

The discrete wavelet conversion section 21 subjects the input image data to discrete wavelet conversion to obtain horizontal and vertical conversion coefficients for each of the first and second scales. The first square circuit 22 squares the horizontal conversion coefficient for the first scale, and the second square circuit 23 squares the vertical conversion coefficient for the first scale. The first adder 24 adds the outputs of the first and second square circuits 22 and 23. Furthermore, the first multiplier 25 calculates the multiplication of the horizontal conversion coefficients for the first and second scales, and the second multiplier 26 calculates the multiplication of the vertical conversion coefficients for the first and second scales. The second adder 27 adds the outputs of the first and second multipliers 25 and 26. The setting section 28 calculates the linear sum of the value resulting from multiplying the output of the first adder 24 by predetermined α, the value resulting from multiplying the output of the second adder 27 by predetermined β, and the value of predetermined γ, and outputs the result. The limiter 29 limits the numerical range of the calculated linear sum.

In this embodiment, as described above, to derive the emphasis control amount e(m,n), the linear sum of the squares of conversion coefficients obtained by discrete binary wavelet conversion of the input image data, the products of conversion coefficients obtained from different scales, and a constant is obtained. In the setting section 28, the emphasis control amount is a positive value in an image contour portion and is a negative value in an image flat portion by selecting the weights for the linear sum. This is input to the limiter 29 that determines the upper limit and the lower limit of the emphasis control amount, the output of the limiter 29 is multiplied by a constant, and the multiplying section 3 multiplies the result by the high-frequency component obtained from the filter output of the input image data. If the output of the limiter 29 is a negative value, namely in an image flat portion, the high-frequency component is subtracted from the input image data, and the apparatus functions as a smoothing filter. If the output of the limiter 29 is a positive value, namely in an image contour portion, the high-frequency component is added to the input image data, and the apparatus functions as an image emphasizing filter.

(Discrete Wavelet Conversion Section 21) Next, the discrete wavelet conversion section 21 will be described.

In general, discrete binary wavelet conversion is defined as a convolution operation between a plurality of wavelet functions and an image. In addition, wavelet conversion is realized by a digital filter having wavelet functions as filter coefficients.

A wavelet function is defined by extending the basic wavelet function in the time-axis direction by a factor of 2^{j}, where j, called a scale, is an integer equal to or larger than 1. If the maximum value of scale j is J, wavelet conversion outputs J scales from scale 1 to scale J and conversion coefficients corresponding to the respective scales.

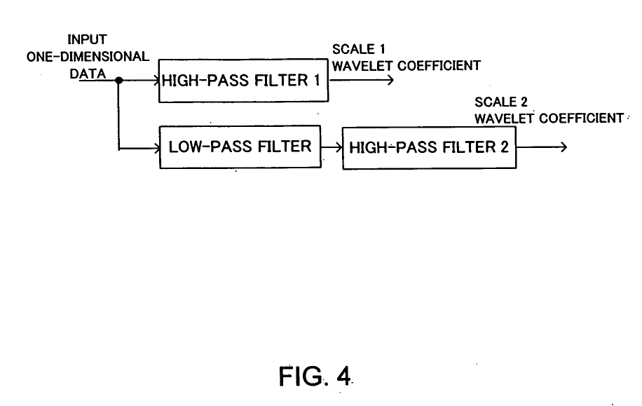

FIG. 4 is a diagram illustrating one-dimensional wavelet conversion where the maximum scale is 2.

Discrete binary wavelet conversion can be realized in a filter bank structure composed of, for example, high-pass filters and a low-pass filter shown in the figure. In other words, if J=2 is set, wavelet conversion of a one-dimensional signal is realized by cascade connection of the filters shown in this figure. For a high-pass filter 1, filter coefficients determined from the basic wavelet function are used. For a high-pass filter 2, filter coefficients having zeros interposed between the samples of the filter coefficients of the high-pass filter are used. This is interpolated with the low-pass filter to derive a wavelet coefficient with 2× scale.

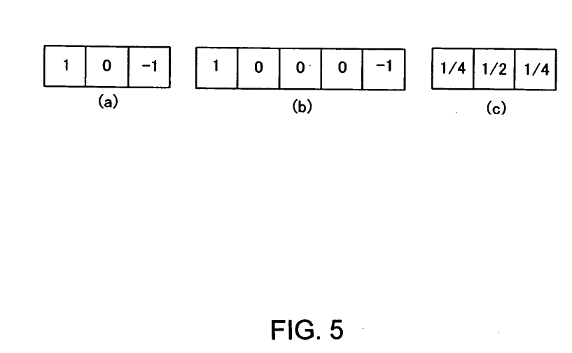

FIG. 5 illustrates an example of coefficients of these three filters for wavelet conversion of one-dimensional signals. FIG. 5(a), FIG. 5(b), and FIG. 5(c) show exemplary filter coefficients of the high-pass filter 1, the high-pass filter 2, and the low-pass filter, respectively.

Assuming that the center in each figure is the center of output, these figures show coefficients by which the surrounding pixels are multiplied. Furthermore, in this example, f(N) (N=n−2, n−1, n, n+1, n+2) with respect to the target pixel f(n) is input as input pixel data for use.

With the filter coefficients shown in the above Figs. (a), (b), and (c), a wavelet coefficient Wf₁(n) for scale 1 with respect to an input signal x(n) is calculated by
Wf₁(n)=x(n−1)−x(n+1).
A low-pass filter output Sf₁(n) is calculated by

$${Sf}_{1} ( n ) = \frac{1}{4} x ( n + 1 ) + \frac{1}{2} x ( n ) + \frac{1}{4} x ( n - 1 )$$

As a result, a wavelet coefficient Wf₁(n) for scale 2 is calculated from Sf₁(n) by
Wf₂(n)=Sf₁(n−2)−Sf₁(n+2).

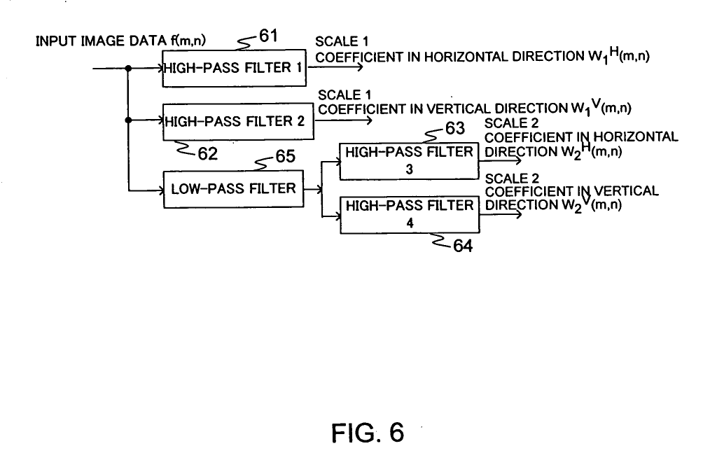

FIG. 6 is a block diagram of a filter bank for achieving two-dimensional wavelet conversion.

The discrete wavelet conversion section 21 includes a high-pass filter 1_61, a high-pass filter 2_62, a high-pass filter 3_63, a high-pass filter 4_64, and a low-pass filter 65.

In the case of image data, which is a two-dimensional signal, one-dimensional filter processing is repeated alternately.

The high-pass filter 1_61 and the high-pass filter 4_64 have the filter coefficients shown in FIG. 5(a) and FIG. 5(b), respectively, and carry out one-dimensional filter processing of each line in the horizontal direction of the image. The high-pass filter 2_62 and the high-pass filter 3_63 have the filter coefficients shown in FIG. 5(a) and FIG. 5(b), respectively, and carry out one-dimensional filter processing of each line in the vertical direction of the image. The low-pass filter 65 is realized by carrying out filter processing of each line in the horizontal direction and then each line in the vertical direction with the filter coefficients shown in FIG. 2(c).

The high-pass filter 1_61 outputs a first conversion coefficient in the horizontal direction, and the high-pass filter 2_62 outputs a first conversion coefficient in the vertical direction. The high-pass filter 3_63 outputs a second conversion coefficient in the horizontal direction, and the high-pass filter 4_64 outputs a second conversion coefficient in the vertical direction.

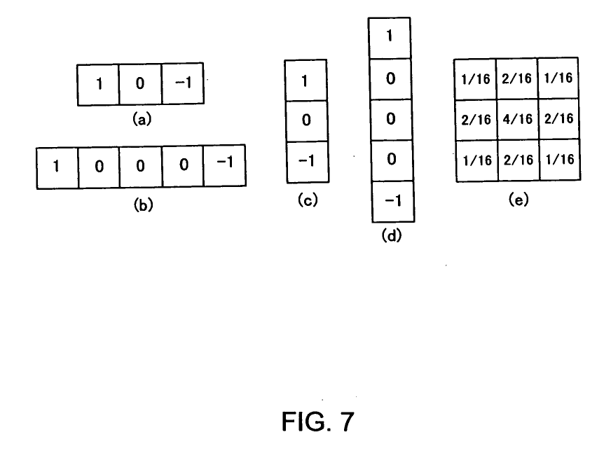

FIG. 7 is a diagram depicting other structures of high-pass filters and a low-pass filter for discrete binary wavelet conversion. Fig. (a), Fig. (b), Fig. (c), Fig. (d), and Fig. (e) show the high-pass filter 1_61, the high-pass filter 3_63, the high-pass filter 2_62, the high-pass filter 4_64, and the low-pass filter 65, respectively. To generate a maximal conversion coefficient in a contour portion, the high-pass filter 1_61 and the high-pass filter 2_62 can use the filter coefficients shown in this figure as an example. Furthermore, to satisfy the law of similarity of wavelet conversion, the filter coefficients shown in this figure, for example, can be used for the low-pass filter 65.

(Setting Section 28)

Next, the setting section 28 of the emphasis-control-amount deriving section 2 will be described. In the setting section 28, constants α, β, and γ are set to calculate the total sum e of α times the sum of the square of the vertical coefficient and the square of the horizontal coefficient for scale 1; β times the sum of the product of the vertical coefficients for scale 1 and scale 2 and the product of the horizontal coefficients for scale 1 and scale 2; and constant γ.

In general, it is known that a wavelet conversion coefficient for scale 1 is equal to or smaller than a wavelet conversion coefficient for scale 2 in contour portions. It is also known that a wavelet conversion coefficient for scale 1 is larger than a wavelet conversion coefficient for scale 2 for noise such as Gaussian noise. By setting, for example, α=−1, β=1, and γ=0, the emphasis control amount can be made to exhibit a positive value only in an image contour portion and to exhibit a negative value in a flat portion. Furthermore, α=0, β=0, and γ=1 are set to achieve uniform contrast emphasis for all pixels. On the other hand, α=0, β=0, and γ=−1 are set to apply uniform smoothing to all pixels. α=0, β=1, and γ=0 are set to achieve image emphasis where noise amplification is suppressed rather than removing noise. By setting the three parameters of the emphasis control section, various advantages, such as simultaneous noise removal and emphasis and emphasis with suppressed noise amplification, can be achieved.

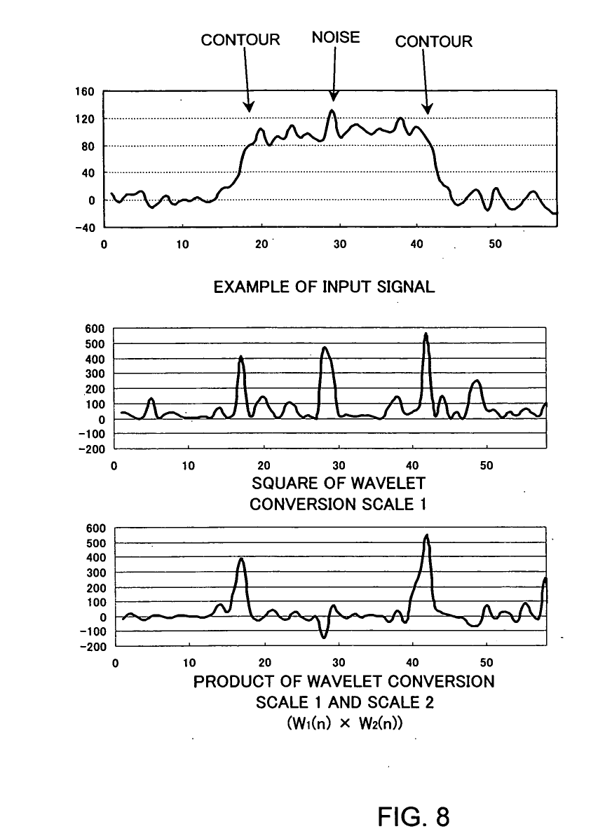

FIG. 8 is a diagram illustrating wavelet conversion of a one-dimensional signal and the product of wavelet conversion scales.

This figure illustrates the relationship between wavelet conversion scales and a signal by way of example of a one-dimensional signal.

In the above figure, as one example, a signal where noise is superimposed on a wave having a brightness value of 100 from 15 points to 45 points and a brightness value of 0 at the other points is used as an input signal. To derive an emphasis control amount from this input signal, the square of wavelet conversion scale 1 and the product of wavelet conversion scale 1 and scale 2 are shown in the form of graphs.

It is difficult to discriminate between noise and image contours with the square of wavelet conversion scale 1 alone. With the product of two scales, however, the contour portions are clearly shown as maximal values based on a characteristic in which the amplitude of the wavelet conversion coefficient decreases only for noise as the scale increases. By multiplying these two feature quantities by the coefficients α and β; adding the constant γ; and setting α, β, and γ so that the emphasis control amount exhibits a negative value in a flat portion and a positive value in an image contour portion, high-pass components in flat portions including noise can be subtracted from the original image to remove noise components included in the high-pass components from the input image data. Setting, for example, (α, β, γ)=(−1, 1, 0) offers an advantage of removing noise in flat portions.

(Limiter 29)

If the total sum e obtained by the above-described calculations is an extremely large positive value, over-emphasis occurs. On the other hand, if the total sum e is an extremely small negative value, noise occurs. To overcome this drawback, the limiter 29 limits the numerical range. U is predetermined as a positive constant and L is predetermined as a negative constant. If the input e to the limiter 29 exceeds U, the limiter 29 outputs U. If the input e to the limiter 29 is below L, the limiter 29 outputs L. Otherwise, the input value e is output as is. When the Laplacian filter shown in the above figure is to be used, setting the value of L to −0.2/λ ensures that this apparatus operates as a smoothing filter in image flat portions.

(Input Pixel Data and Derivation of Emphasis Control Amount)

Pixels of input image data and pixels used to derive an emphasis control amount for each pixel will now be described.

The brightness value at coordinates (m,n) of the input image data is expressed as f(m,n), and the wavelet conversion result and the emphasis control amount are also determined for each set of coordinates (m,n), as shown in a sequence in the figure.

The input image data used for image processing includes pixels around the target pixel f(m,n) that are required for the calculation of two-dimensional wavelet conversion. These input image data are pre-stored, for example, in a memory, and are read out by the deriving section for use as necessary. For example, in this embodiment, the high-pass and low-pass filters calculate discrete binary wavelet conversion of the target pixel f(m,n) using surrounding pixel data required for filter processing, as shown in FIG. 7 and other figures. Furthermore, the output image data can also be used recursively.

In addition, for relationships among pixels used to derive an emphasis control amount, the derivation of wavelet coefficients for determining the emphasis control amount is as described above. Furthermore, for the emphasis control amount e(m,n),
e(m,n)=F[α((W₁^{H}(m,n))²+(W₁^{V}(m,n))²)+β(W₁^{H}(m,n)W₂^{H}(m,n)+W₁^{V}(m,n)W₂^{V}(m,n))+γ]
where F[·] is explicitly represented in the form of a formula as a nonlinear function indicating the input and output relationship of the limiter 29.

In the present invention, the emphasis control amount exhibits a positive value and a negative value depending on the magnitude relationship between conversion coefficients for different scales of discrete binary wavelet conversion. The advantage of emphasis is offered in the case of a positive value, and the advantage of noise removal is offered in the case of a negative value. The magnitude relationship between discrete binary wavelet conversion coefficients does not depend on the brightness amplitude and the contrast of an image, but differs between image contours and noise. Therefore, it is possible to emphasize only image contour portions without being affected by the magnitude of contrast in contour portions or the noise amplitude.

2. Example of Image Processing

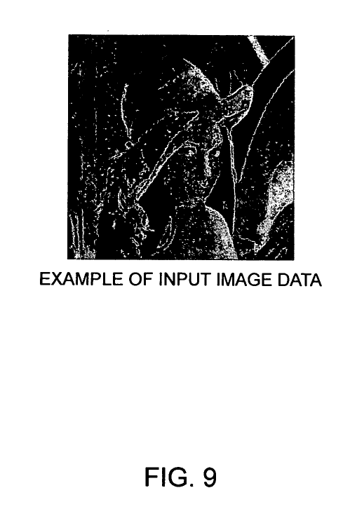

An input image data shown in FIG. 9 was used to demonstrate the effect of noise removal and contour emphasis according to this embodiment. FIG. 9 shows an image produced by applying a 3-by-3-pixel average filter to a certain image and then superimposing Gaussian noise with a variance of 50 on the resultant image.

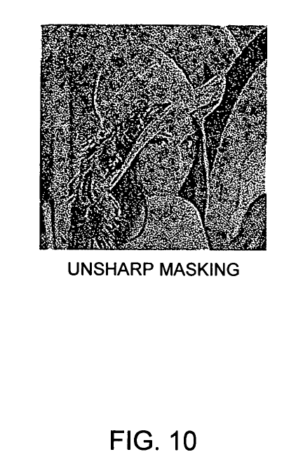

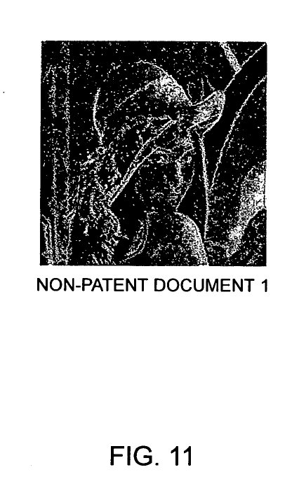

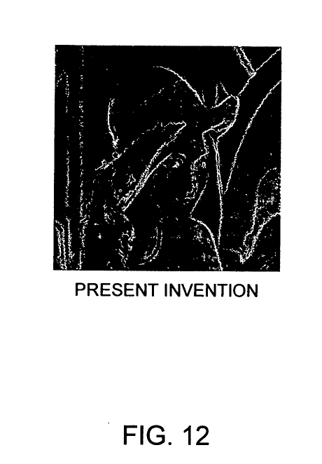

FIG. 10 is a diagram depicting a processing result by the unsharp masking method, which is a known method. FIG. 11 is a diagram depicting a processing result of an emphasized image produced by the method shown in Non-Patent Document 1. On the other hand, FIG. 12 is a diagram depicting a processing result of noise removal and emphasis of contour portions being carried out simultaneously according to the present invention. To acquire the result of FIG. 12, the constant λ was set as 0.001, and α=−1, β=1, γ=0, and L=−0.2/λ were set, as one example.

Comparing the three emphasized images, despite the fact that image contour portions have the same degree of emphasis, the noise on the image background of the emphasized image (FIG. 12) according to the present invention is decreased more than that on the images according to the other methods. This shows that the present invention is advantageous.

3. Image Processing Program

An image processing method or an image processing apparatus and system according to the present invention can be provided by, for example, an image processing program for causing a computer to execute each of the procedures thereof; a computer-readable recording medium having recorded the image processing program; a program product that includes the image processing program and that can be loaded into an internal memory of a computer; and a computer, such as a server, that includes the program.

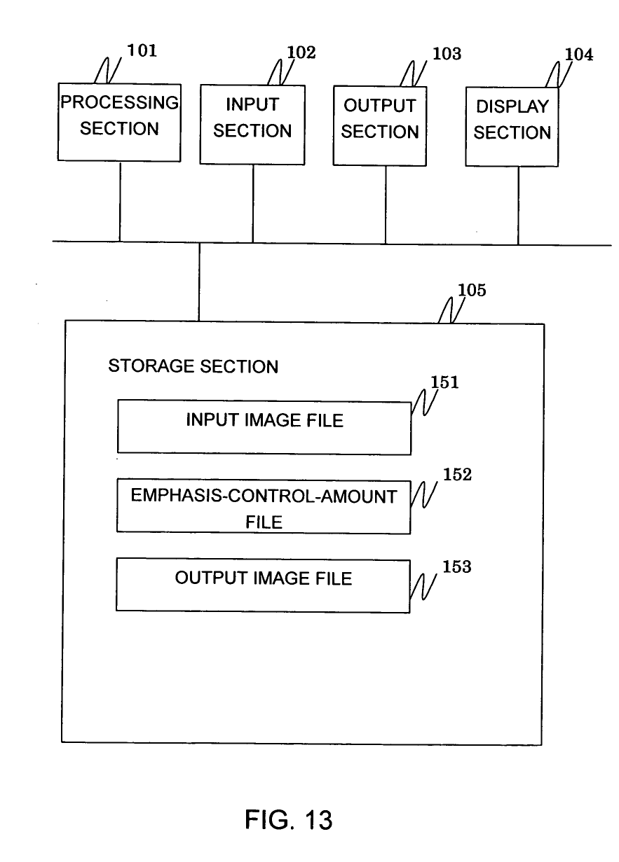

FIG. 13 is a block diagram of hardware according to this embodiment.

This hardware includes a processing section 101 which is a central processing unit (CPU); an input section 102; an output section 103; a display section 104; and a storage section 105. Furthermore, the processing section 101, the input section 102, the output section 103, the display section 104, and the storage section 105 are connected with appropriate connecting means such as a star or a bus. The storage section 105 includes an input image file 151 for storing an input image data f(m,n) to be subjected to image processing, an emphasis-control-amount file 152 for storing a calculated emphasis control amount e(m,n), and an output image file 153 for storing an output image data subjected to image processing.

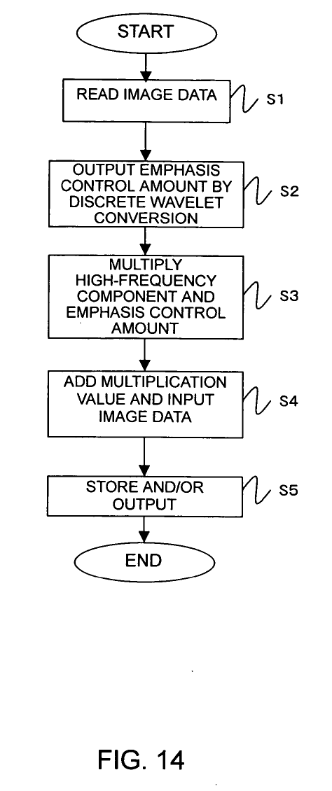

FIG. 14 is a flowchart for image processing. Details of each processing operation is the same as those described in “1. Image processing apparatus.”

The image processing program removes noise and emphasizes the contrast of contour portions of an input image by causing a computer to execute the following processing. First, the processing section 101 reads an input image data from the input image file 151 of the storage section 105 or the input section 102 (step S1). The processing section 101 obtains first and second conversion coefficients having different magnitude relationships between an image contour portion and noise by subjecting the input image data to discrete wavelet conversion, and obtains an emphasis control amount based on the square of the first conversion coefficient, the products of the first and second conversion coefficients, and a predetermined setting value (step S2). The processing section 101 stores the obtained emphasis control amount in the emphasis-control-amount file 152, as necessary. The processing section 101 outputs the product of the emphasis control amount and a high-frequency component of the input image data (step S3). The processing section 101 causes an adding section to add the product and the input image data to obtain output image data (step S4). The processing section 101 stores the obtained output image data in the output image file 153 of the storage section 105 and/or outputs it to the output section 103 or to the display section 104 (step S5). The processing section 101 can also obtain further output image data by recursively performing the above-described image processing based on the obtained output image data.

### INDUSTRIAL APPLICABILITY

According to the present invention, the amount of computational processing by the proposed method increases only by an amount corresponding to the computation of the low-pass filter and the high-pass filters 3 and 4 required to derive wavelet conversion coefficients of scale 2 and an amount corresponding to the computation for deriving an emphasis control amount (eight multiplications, four additions, and two threshold value operations per pixel), compared with the method described in Non-Patent Document 1, while the proposed method offers noise removal capability. Considering that it has been difficult to achieve noise removal where only image contour portions are saved with nearly the same amount of computational processing as this increased amount, the amount of computational processing for achieving both emphasis and noise removal simultaneously can be substantially reduced with the present invention.

According to the present invention, emphasis, noise removal, or both can be achieved simultaneously by changing the constants (α, β, and γ) of the emphasis-control-amount deriving section 2, without modifying the entire apparatus, to obtain various emphasis characteristics.

Since the known technologies (Non-Patent Documents 1 and 2 and Patent Document 1) separate noise from image contours by methods depending on the brightness amplitude and difference, the effect for suppressing the noise amplification decreases when the contrast of input image data is low and the noise amplitude is large. In contrast, according to the present invention, since noise is discriminated from image contours depending on the magnitude relationship, between scales, of discrete binary wavelet conversion coefficients, noise removal and image emphasis can be achieved without depending on the contrast and noise amplitude of the input image data.

The present invention is suitable particularly for sharpening of input images in digital cameras, digital video cameras, and image scanners, for example.

1. An image processing apparatus for removing noise of an input image and for emphasizing contrast of a contour portion, comprising:
a filter for passing a high-frequency component of input image data therethrough;
a deriving section for obtaining first and second conversion coefficients having different magnitude relationships between an image contour portion and noise by subjecting the input image data to discrete wavelet conversion and for obtaining an emphasis control amount based on the square of the first conversion coefficient, the product of the first and second conversion coefficients, and a predetermined setting value;
a multiplying section for outputting the product of the emphasis control amount sent from the deriving section and an output of the filter; and
an adding section for obtaining output image data by adding the product output from the multiplying section and the input image data.

2. An image processing apparatus according to claim 1, wherein the deriving section outputs a negative value for image flat portion to cause the adding section to subtract high-frequency component from the input image data, and the deriving section outputs a positive value for the image contour portion to cause the adding section to add the hi˜frequency component to the input image data.

3. An image processing apparatus according to claim 1, wherein the deriving section comprises:
a discrete wavelet conversion section for obtaining the first and second conversion coefficients by subjecting the input image data to discrete wavelet conversion;
a first circuit having a square circuit for squaring the first conversion coefficient;
a second circuit having a multiplier for multiplying the first and second conversion coefficients; and
a setting section for calculating and outputting a linear sum of a value obtained by multiplying an output of the first circuit by predetermined α, a value obtained by multiplying an output of the second circuit by predetermined β, and the value of predetermined γ.

4. An image processing apparatus according to claim 3, wherein the setting section causes the emphasis control amount to be a positive value in the image contour portion and to be a negative value in a flat portion by setting α=−1, β=1 and γ=0.

5. An image processing apparatus according to claim 3, wherein the setting section achieves uniform contrast emphasis for all pixels by setting α=0, β=0, and γ=1.

6. An image processing apparatus according to claim 3, wherein the setting section applies smoothing to all pixels uniformly by setting α=0, β=0, and γ=−1.

7. An image processing apparatus according to claim 3, wherein the setting section achieves image emphasis with noise amplification being suppressed, without removing noise, by setting α=0, β=1, and γ=0.

8. An image processing apparatus according to claim 1, wherein the deriving section comprises a discrete wavelet conversion section, the discrete wavelet conversion section comprising:
a first high-pass filter for carrying out one-dimensional filter processing of each line in a horizontal direction of the input image data to output the first conversion coefficient in the horizontal direction;
a second high-pass filter for carrying out one-dimensional filter processing of each line in a vertical direction of the input image data to output the first conversion coefficient in the vertical direction;
a low-pass filter for carrying out filter processing of each line in the horizontal direction and for carrying out filter processing of each line in the vertical direction of the input image data;
a third high-pass filter for carrying out one-dimensional filter processing of each line in the horizontal direction of an output from the low-pass filter to output the second conversion coefficient in the horizontal direction; and
a fourth high-pass filter for carrying out one-dimensional filter processing of each line in the vertical direction of the output from the low-pass filter to output the second conversion coefficient in the vertical direction.

9. An image processing apparatus according to claim 1, wherein the deriving section further comprises a limiter for limiting a numerical range of a calculated linear sum.

10. An image processing apparatus according to claim 1, further comprising an amplifying section for determining a degree of emphasis by multiplying an output of the multiplying section by a constant and outputting the product to the adding section.

11. An image processing method of removing noise of an input image and of emphasizing contrast of a contour portion, comprising:
obtaining first and second conversion coefficients having different magnitude relationships between an image contour portion and noise by subjecting input image data to discrete wavelet conversion and obtaining an emphasis control amount based on the square of the first conversion coefficient, the product of the first and second conversion coefficients, and a predetermined setting value;
outputting the multiplication value of the emphasis control amount and a high-frequency component of the input image data; and
obtaining output image data by adding the multiplication value and the input image data.

12. An image processing method according to claim 11, comprising calculating and outputting a linear sum of a value obtained by multiplying the square of the first conversion coefficient by predetermined α, a value obtained by multiplying the product of the first and second conversion coefficients by predetermined β, and the value of predetermined γ.

13. An image processing method according to claim 12, wherein, the emphasis control amount is a positive value in the image contour portion and a negative value in a flat portion by setting α=−1, β=1, and γ=0.

14. An image processing program for removing noise and emphasizing contrast in a contour portion of an input image, the image processing program causing a computer to make a processing section execute the steps of:
reading input image data from a storage section or an input section;
obtaining first and second conversion coefficients having different magnitude relationships between an image contour portion and noise by subjecting the input image data to discrete wavelet conversion and obtaining an emphasis control amount based on the square of the first conversion coefficient, the product of the first and second conversion coefficients, and a predetermined setting value;
outputting a multiplication value of the emphasis control amount and a high-frequency component of the input image data;
to obtaining output image data by adding the multiplication value and the input image data; and
storing the obtained output image data in a storage section and/or outputting the obtained output image data to an output section or to a display section.

15. A computer-readable recording medium having recorded an image processing program for removing noise and emphasizing contrast in a contour portion of an input image, the image processing program causing a computer to make a processing section execute the steps of: reading input image data from a storage section or an input section;
obtaining first and second conversion coefficients having different magnitude relationships between an image contour portion and noise by subjecting the input image data to discrete wavelet conversion and obtaining an emphasis control amount based on the square of the first conversion coefficient, the product of the first and second conversion coefficients, and a predetermined setting value;
outputting a multiplication value of the emphasis control amount and a high-frequency component of the input image data;
obtaining output image data by adding the multiplication value and the input image data; and
storing the obtained output image data in a storage section and/or outputting the obtained output image data to an output section or to a display section.
